(19) United States
(12) Patent Application Publication
(10) Pub. No.: US 2026/0307479 A1
(43) Pub. Date: Oct. 8, 2026

(54) Drive Force Control Method and Drive Force Control Device

(71) Applicant: Nissan Motor Co., Ltd., Yokohama-shi, Kanagawa (JP)

(72) Inventor: Masato Koga, Kanagawa (JP)

(21) Appl. No.: 19/482,359

(22) PCT Filed: May 11, 2023
(86) PCT No.: PCT/JP2023/017773

§ 371 Date: Nov. 7, 2025

(51) Int. Cl. B60K 23/08; B60L 15/20

(52) U.S. Cl. CPC B60K 23/0808; B60L 15/20

(57) ABSTRACT

A driving force control method for a vehicle independently driven in the front and rear, controls a torque distribution ratio of each drive device so to straddle between an in-phase range, in which signs of an output torque of each drive device coincide with each other, and an out-of-phase range, in which the signs are different. A backlash elimination control for limiting the magnitude of the output torque of the drive device in which positive and negative signs are reversed at phase transition, relative to the magnitude of a basic command torque determined according to the torque distribution ratio, is executed. When the basic command torque reaches a predetermined control start torque, the backlash elimination control is started. When the vehicle is accelerated and/or decelerated, the control start torque is set to a corrected control start torque different from the basic control start torque used during constant speed traveling.

### TECHNICAL FIELD

The present invention relates to a drive force control method and a drive force control device.

### BACKGROUND ART

JP2009-47080A discloses a drive torque control method for maintaining an output torque of a prime mover at a predetermined value (backlash reducing torque) smaller than a prime mover required torque corresponding to an operation of a driver during switching of a drive state from a reverse drive state to a normal drive state of a drive force transmission system including a transmission. According to this control method, a transmission input torque can be reduced, and rotation acceleration corresponding to a gear backlash can be reduced, so that an acceleration shock (backlash reducing shock) can be reduced.

### SUMMARY OF INVENTION

On the other hand, in recent years, a vehicle equipped with drive devices that are capable of driving independently in a front-rear direction (for example, a 4 WD electric vehicle including a front motor and a rear motor) becomes widespread. In this type of vehicle, a drive force distribution (torque distribution ratio) between front and rear wheels is appropriately adjusted according to a traveling scene.

Especially, from a viewpoint of achieving a desired vehicle behavior, the torque distribution ratio may be adjusted so as to cover an in-phase range in which signs of output torques of the drive devices are the same, and an out-of-phase range in which the signs are different from each other. However, when such phase transition occurs, the output torque of the drive device whose sign is switched is excessive or insufficient with respect to an initial required torque corresponding to a vehicle speed. Therefore, when the backlash reducing control is executed in a scene in which the phase transition occurs during acceleration or deceleration of the vehicle, the output torque is limited, so that a deviation occurs between a rotation speed of the drive device (a rotation speed on an input shaft side) and a vehicle speed equivalent rotation speed (a rotation speed on a wheel shaft side). As a result, there is a problem that the intended backlash reducing effect cannot be obtained, and the backlash reducing time becomes long or the like so that a backlash reducing shock becomes large.

Therefore, an object of the present invention is to provide a drive force control method and a drive force control device capable of further reducing a backlash reducing shock when performing backlash reducing control in a vehicle including drive devices that are capable of driving independently in a front-rear direction.

According to an aspect of the present invention, there is provided a drive force control method for controlling a torque distribution ratio between drive devices provided in a vehicle that are capable of driving independently in a front-rear direction, to cover an in-phase range in which signs of output torques of the drive devices are the same, and an out-of-phase range in which the signs are different from each other. In this drive force control method, backlash reducing control is executed for limiting a magnitude of the output torque of one of the drive devices whose sign is inverted during phase transition to a magnitude of a basic command torque determined according to the torque distribution ratio. Especially, during acceleration and/or deceleration of the vehicle, the control start torque is set to a correction control start torque different from a basic control start torque used during constant speed traveling.

### BRIEF DESCRIPTION OF DRAWINGS

FIG. 1 is a diagram illustrating a prerequisite configuration of a vehicle in which a drive force control method according to each embodiment of the present invention is executed.

FIG. 2 is a block diagram illustrating a configuration of a drive force control device.

FIG. 3 is a flowchart showing each processing of the drive force control method.

FIG. 4 is a diagram illustrating an example of an offset torque map.

FIG. 5 is a diagram illustrating an example of a torque gradient map.

FIG. 6 is a timing chart showing a control result in a scene of phase transition from out-of-phase to in-phase during acceleration.

FIG. 7 is a timing chart showing a control result in a scene of phase transition from the in-phase to the out-of-phase during acceleration.

FIG. 8 is a timing chart showing a control result in a scene of phase transition from the out-of-phase to the in-phase during deceleration.

FIG. 9 is a timing chart showing a control result in a scene of phase transition from the in-phase to the out-of-phase during deceleration.

### DESCRIPTION OF EMBODIMENTS

Hereinafter, each embodiment of the present invention will be described in detail with reference to the drawings.

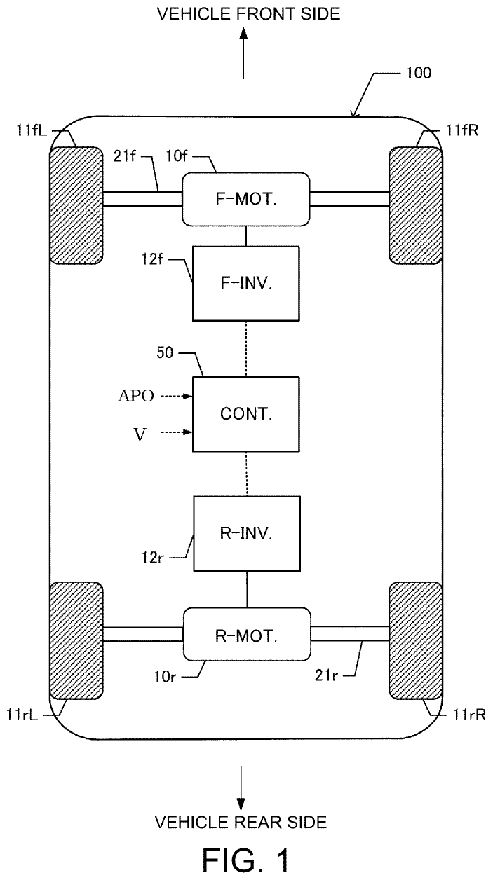

FIG. 1 is a diagram illustrating a prerequisite configuration of a vehicle 100 to which a drive force control method according to the present embodiment is applied. Note that as the vehicle 100, an electric vehicle, a hybrid vehicle, or the like, which includes drive motors 10 serving as drive devices capable of driving independently in a front-rear direction, and can travel by drive forces from the drive motors 10, is assumed.

Especially, the drive motors 10 include a front motor 10f provided at a front position (front wheel side) of the vehicle 100 to drive front wheels 11f, and a rear motor 10r provided at a rear position (rear wheel side) to drive rear wheels 11r.

The front motor 10f is implemented by a three-phase AC motor. During power running, the front motor 10f is supplied with electric power from an in-vehicle battery to generate the drive force. The drive force generated by the front motor 10f is transmitted to the front wheels 11f via a front drive system (not illustrated) and a front drive shaft 21f. On the other hand, during regeneration, the front motor 10f converts a regenerative brake force of the front wheels 11f into AC electric power and supplies the AC electric power to the in-vehicle battery.

On the other hand, the rear motor 10r is implemented by a three-phase AC motor. During power running, the rear motor 10r is supplied with the electric power from the in-vehicle battery to generate the drive force. The drive force generated by the rear motor 10r is transmitted to the rear wheels 11r via a rear drive system (not illustrated) and a rear drive shaft 21r. During regeneration, the rear motor 10r converts a regenerative brake force of the rear wheels 11r into AC electric power and supplies the AC electric power to the in-vehicle battery.

An inverter 12 includes a front inverter 12f that adjusts the electric power (positive in the power running and negative in the regeneration) supplied to the front motor 10f, and a rear inverter 12r that adjusts the electric power (positive in the power running and negative in the regeneration) supplied to the rear motor 10r.

The front inverter 12f adjusts the electric power supplied to the front motor 10f so that a total required torque Tsum corresponding to a total drive force required for the vehicle 100 and an output torque of the front motor 10f according to a predetermined torque distribution ratio κ (hereinafter referred to as “front motor torque T_f”) are achieved. On the other hand, the rear inverter 12r adjusts the electric power supplied to the rear motor 10r so that the total required torque Tsum and an output torque of the rear motor 10r according to the torque distribution ratio κ (hereinafter referred to as “rear motor torque T_r”) are achieved.

Note that the total required torque Tsum is determined based on, for example, an operation amount (accelerator opening APO) for an accelerator pedal by an occupant of the vehicle 100, or a command drive force received from a predetermined autonomous driving system (autonomous driving control device) such as an advanced driver assistance system (ADAS) or autonomous driving (AD), and a vehicle speed V.

Further, the vehicle 100 is provided with a controller 50 that functions as a drive force control device. The controller 50 is implemented by a computer including a central processing unit (CPU), a read-only memory (ROM), a random access memory (RAM), and an input and output interface (I/O interface), and is programmed to execute each processing in vehicle control described below. Especially, the functions of the controller 50 can be implemented by any in-vehicle computer such as a vehicle controller (vehicle control module (VCM)) or a motor controller (VMC), and/or a computer provided outside the vehicle 100. Note that the controller 50 may be implemented by one piece of computer hardware, or may be implemented by distributing various kinds of processing by a plurality of pieces of computer hardware.

The controller 50 determines a basic command value of the front motor torque T_f (hereinafter, referred to as a “basic command front motor torque T*_f”) and a basic command value of the rear motor torque T_r (hereinafter, referred to as a “basic command rear motor torque T*_r”) according to the torque distribution ratio κ, using the total required torque Tsum and detection values (acceleration a, vehicle speed V, and the like of the vehicle 100) by sensors (not illustrated) as input information. Note that the basic command front motor torque T*_f and the basic command rear motor torque T*_r will also be collectively referred to as a “basic command motor torque T*” as appropriate below.

Further, the controller 50 corrects the basic command front motor torque T*_f and the basic command rear motor torque T*_r by backlash reducing control described later to calculate a final command front motor torque T**_f and a final command rear motor torque T**_r. Then, the controller 50 controls the electric power supplied to the motors 10f and 10r by operating the inverters 12f and 12r based on the final command front motor torque T**_f and the final command rear motor torque T**_r. Note that the final command front motor torque T**_f and the final command rear motor torque T**_r will also be collectively referred to as a “final command motor torque T**” as appropriate below. Hereinafter, the control in the controller 50 will be described in more detail.

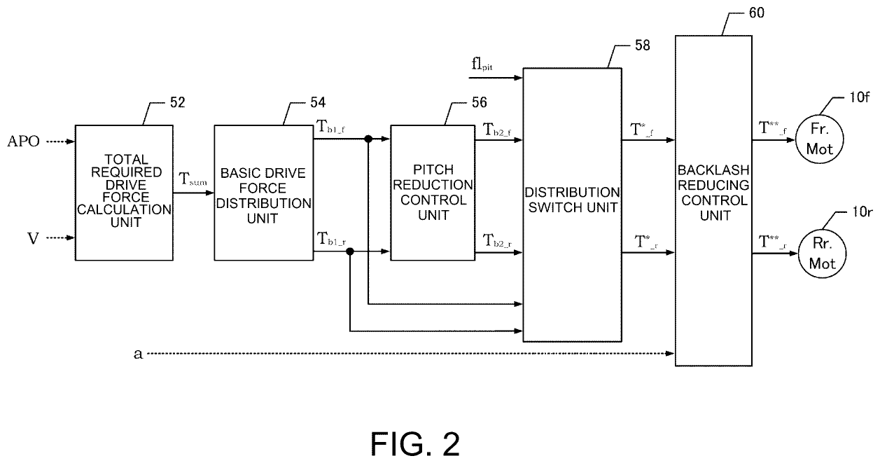

FIG. 2 is a block diagram illustrating a configuration of the controller 50. As illustrated in the drawing, the controller 50 includes a total required drive force calculation unit 52, a basic drive force distribution unit 54, a pitch reduction control unit 56, a distribution switch unit 58, and a backlash reducing control unit 60.

The total required drive force calculation unit 52 calculates the total required torque Tsum by using the accelerator opening APO and the vehicle speed V as inputs. More specifically, the total required drive force calculation unit 52 obtains the total required torque Tsum from the acquired accelerator opening APO and the vehicle speed V with reference to a map in which a correlation among the accelerator opening APO, the vehicle speed V, and the appropriate total required torque Tsum is determined in advance.

The basic drive force distribution unit 54 calculates a first basic front motor torque Tb1_f and a first basic rear motor torque Tb1_r from the total required torque Tsum and a predetermined basic distribution ratio κb. Note that the basic distribution ratio κb is a basic value of the torque distribution ratio κ determined by experiments, simulations, or the like so as to achieve desired vehicle characteristics. Especially, the vehicle characteristics mainly include characteristics related to an efficiency of energy consumed by operations such as traveling of the vehicle 100 (fuel efficiency performance or electricity efficiency performance). More specifically, the basic distribution ratio κb is set to an appropriate value (for example, 50:50) in a range of 0 to 100:100 to 0 (that is, a positive in-phase range) during acceleration of the vehicle 100. On the other hand, the basic distribution ratio κb is set to an appropriate value (for example, −50:−50) in a range of −100 to 0:0 to −100 (a negative in-phase range) during deceleration of the vehicle 100.

The pitch reduction control unit 56 calculates a second basic front motor torque Tb2_f and a second basic rear motor torque Tb2_r from the first basic front motor torque Tb1_f and the first basic rear motor torque Tb1_r. More specifically, the pitch reduction control unit 56 calculates the second basic front motor torque Tb2_f and the second basic rear motor torque Tb2_r by correcting the first basic front motor torque Tb1_f and the first basic rear motor torque Tb1_r so as to achieve the torque distribution ratio κ determined according to a desired pitch characteristic of the vehicle 100.

Here, pitch reduction control means, for example, control for adjusting a pitch behavior of a vehicle body so as to reduce vibration transmitted to the occupant in a scene of traveling on steps or uneven surfaces. Especially, the torque distribution ratio κ to be achieved in the pitch reduction control is set to cover not only an in-phase range in which signs of the front motor torque Tf and the rear motor torque Tr coincide with each other, but also an out-of-phase range in which the signs are different from each other.

More specifically, the out-of-phase range includes a torque distribution ratio κ in which the front motor torque Tf is negative and the rear motor torque Tr is positive, and a torque distribution ratio κ in which the front motor torque Tf is positive and the rear motor torque Tr is negative.

The distribution switch unit 58 determines the basic command front motor torque T*_f and the basic command rear motor torque T*_r with reference to a pitch reduction control execution flag flpit. More specifically, when the pitch reduction control execution flag flpit is in an on state (when there is an execution request for the pitch reduction control), the distribution switch unit 58 determines the second basic front motor torque Tb2_f and the second basic rear motor torque Tb2_r calculated by the pitch reduction control unit 56 as the basic command front motor torque T*_f and the basic command rear motor torque T*_r, respectively, and outputs the results to the backlash reducing control unit 60.

On the other hand, when the pitch reduction control execution flag flpit is in an off state (when there is no execution request for the pitch reduction control), the distribution switch unit 58 determines the first basic front motor torque Tb1_f and the first basic rear motor torque Tb1_r calculated by the basic drive force distribution unit 54 as the basic command front motor torque T*_f and the basic command rear motor torque T*_r, respectively, and outputs the results to the backlash reducing control unit 60.

The backlash reducing control unit 60 executes the backlash reducing control to correct the basic command front motor torque T*_f and the basic command rear motor torque T*_r, and calculates the final command front motor torque T**_f and the final command rear motor torque T**_r. Note that in the present embodiment, the backlash reducing control is control for limiting a magnitude (|T|) of the motor torque Tin the drive motor 10 whose sign is inverted when the phase transition is performed to a value smaller than a magnitude (|T*|) of the basic command motor torque T* determined according to the torque distribution ratio κ to reduce a backlash reducing shock.

When the basic command motor torque T* set in the drive motor 10 on which the phase transition is performed reaches a predetermined control start torque Tth determined to be close to a zero torque, the backlash reducing control unit 60 in the present embodiment sets the motor torque T (final command motor torque T**) to a backlash reducing torque Tlim instead of the basic command motor torque T*. Especially, in the present embodiment, when the vehicle 100 is in constant speed traveling, the control start torque Tth is set to the basic control start torque Tthb. On the other hand, during acceleration or deceleration of the vehicle 100, the control start torque Tth is set to a correction control start torque Tthc different from the basic control start torque Tthb. Hereinafter, the backlash reducing control will be described in detail.

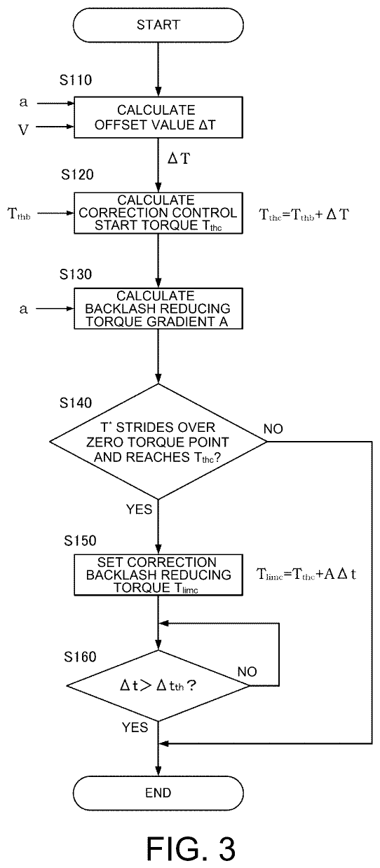

FIG. 3 is a flowchart illustrating details of the backlash reducing control according to the present embodiment. Note that the controller 50 (more specifically, the backlash reducing control unit 60) repeatedly executes each processing shown in FIG. 3 at a predetermined calculation cycle.

First, in step S110, the controller 50 calculates an offset torque ΔT from the acceleration a and the vehicle speed V of the vehicle 100. Here, the offset torque ΔT is a torque correction value determined in consideration of an offset amount corresponding to a drive system inertia during acceleration and deceleration of the vehicle 100 with respect to the basic control start torque Tthb used for the constant speed traveling. Especially, the offset amount corresponding to the drive system inertia is a torque difference determined according to a deviation between a motor rotation speed Nm in the drive motor 10 whose sign is inverted in the phase transition and a rotation speed on an output shaft side determined according to the current vehicle speed V (wheel speed) (hereinafter, referred to as a “vehicle speed equivalent rotation speed”). Note that the deviation between the motor rotation speed Nm and the vehicle speed equivalent rotation speed is evaluated in consideration of a drive system transmission ratio on the side whose sign is inverted in the phase transition.

Especially, in the present embodiment, the controller 50 obtains the offset torque ΔT from the acceleration a and the vehicle speed V with reference to an offset torque map M1 prepared in advance.

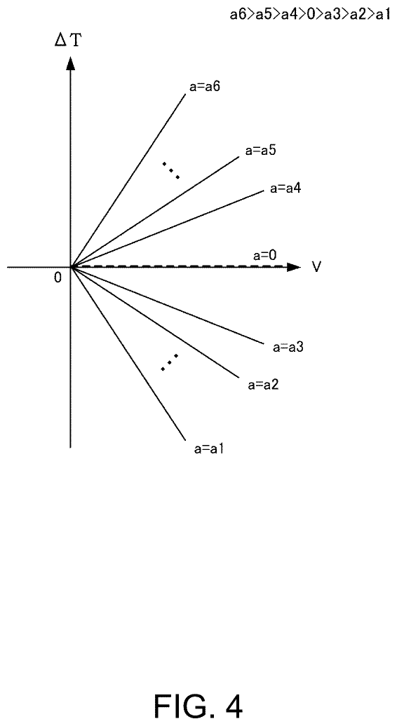

FIG. 4 is a diagram illustrating an example of the offset torque map M1. As illustrated in the drawing, in the present embodiment, during acceleration (when acceleration a>0), the offset torque ΔT is set to a positive value whose absolute value increases as the vehicle speed V increases and/or as the acceleration a increases. That is, during acceleration, the offset torque ΔT is set to take a positive value that increases as the vehicle speed V increases and/or as the acceleration a increases.

On the other hand, during deceleration (acceleration a<0), the offset torque ΔT is set to a negative value whose absolute value increases as the vehicle speed V increases and/or as the acceleration a increases. That is, during deceleration, the offset torque ΔT is set to take a negative value that decreases as the vehicle speed V increases and/or as the acceleration a decreases.

When the acceleration a is 0 (during constant speed traveling), the offset torque ΔT is a predetermined basic value (set to 0 in FIG. 4).

Next, in step S120, the controller 50 calculates the correction control start torque Tthc by adding the offset torque ΔT calculated in step S110 to the basic control start torque Tthb memorized in advance.

Returning to FIG. 3, in step S130, the controller 50 calculates a backlash reducing torque gradient A from the acceleration a. Here, the backlash reducing torque gradient A is a gradient of an increase or decrease change with the control start torque Tth (in particular, the correction backlash reducing torque Tlimc) of the backlash reducing torque Tlim (in particular, the correction backlash reducing torque Tlimc) set during the backlash reducing control as a base point. Especially, the controller 50 calculates the backlash reducing torque gradient A from the acceleration a with reference to the torque gradient map M2 prepared in advance.

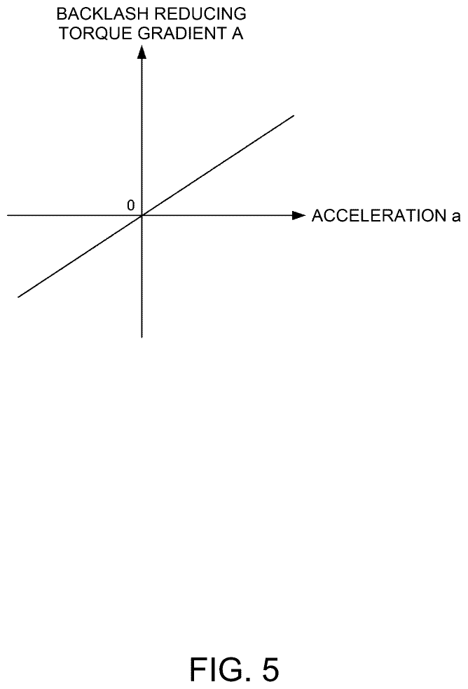

FIG. 5 is a diagram illustrating an example of a torque gradient map M2. As illustrated in the drawing, the backlash reducing torque gradient A is set to a positive value whose absolute value increases as the acceleration a increases during acceleration (when the acceleration a is positive). That is, during acceleration, the backlash reducing torque gradient A is set to a positive value that increases as the acceleration a increases.

On the other hand, during deceleration (when the acceleration a is negative), the backlash reducing torque gradient A is set to a negative value whose absolute value increases as the acceleration a decreases. That is, during deceleration, the backlash reducing torque gradient A is set to a negative value that decreases as a deceleration increases.

Returning to FIG. 3, in step S140, the controller 50 determines whether the basic command motor torque T* crosses a zero torque point and reaches the correction control start torque Tthc. When a result of the determination is positive, the controller 50 sets the correction backlash reducing torque Tlimc to the final command motor torque T**. Note that the correction backlash reducing torque Tlimc is calculated by adding a product (A×Δt) of the backlash reducing torque gradient A and a control duration Δt of the backlash reducing control appropriately determined to the correction control start torque Tthc.

As understood from FIGS. 4 and 5, during acceleration, both the offset torque ΔT and the backlash reducing torque gradient A are set to positive values. Therefore, the correction backlash reducing torque Tlimc becomes a positive value greater than the basic control start torque Tthb. On the other hand, during deceleration, both the offset torque ΔT and the backlash reducing torque gradient A are set to negative values. Therefore, the correction backlash reducing torque Tlimc becomes a negative value smaller than the basic control start torque Tthb. During constant speed traveling, the offset torque ΔT and the backlash reducing torque gradient A are both set to basic values (more specifically, 0) independent of the vehicle speed V. Therefore, the backlash reducing torque Tlim during constant speed traveling determined according to the above logic coincides with the basic control start torque Tthb. Note that a correlation among an acceleration or deceleration state, a phase transition mode, the offset torque ΔT, and the backlash reducing torque gradient A of the vehicle 100 in the present embodiment is shown in the following Table 1.

TABLE 1

| Acceleration or | Phase | | Backlash reducing |
|---|---|---|---|
| deceleration state | transition | Torque offset ΔT | torque gradient A |
| Constant speed | — | Basic value | Basic value |
| Acceleration | Negative → | Positive | Positive gradient |
| | positive | | |
| | Positive → | | |
| | negative | | |
| Deceleration | Negative → | Negative | Negative gradient |
| | positive | | |
| | Positive → | | |
| | negative | | |

Returning to FIG. 3, in step S160, the controller 50 determines whether the control duration Δt of the backlash reducing control exceeds a predetermined threshold time Δtth, and when a result of the determination is positive, the controller 50 ends the backlash reducing control. That is, the controller 50 sets the final command motor torque T** to the correction backlash reducing torque Tlimc until the control duration reaches the threshold time Δtth, and returns the final command motor torque T** to the basic command motor torque T* when the control duration exceeds the threshold time Δtth. Note that the threshold time Δtth is set to an appropriate value through experiments or simulations from a viewpoint of reducing the backlash reducing shock. Especially, the threshold time Δtth may be appropriately set to different values depending on whether the basic command motor torque T* crosses the correction control start torque Tthc in a positive-to-negative direction (whether the phase transition is from positive to negative) or in a negative-to-positive direction (whether the phase transition is from negative to positive).

On the other hand, when a result of the determination in step S140 is negative, the controller 50 ends the backlash reducing control. That is, in this case, it is determined to be a scene in which torque correction for backlash reducing is unnecessary, and this routine is ended.

Next, a control result when the backlash reducing control according to the present embodiment (example) is executed will be described. Note that a control result in a case where the drive motor 10 whose torque sign is inverted is the rear motor 10r will be described below. On the other hand, the following description can be similarly applied to a case where the drive motor 10 whose torque sign is inverted is the front motor 10f.

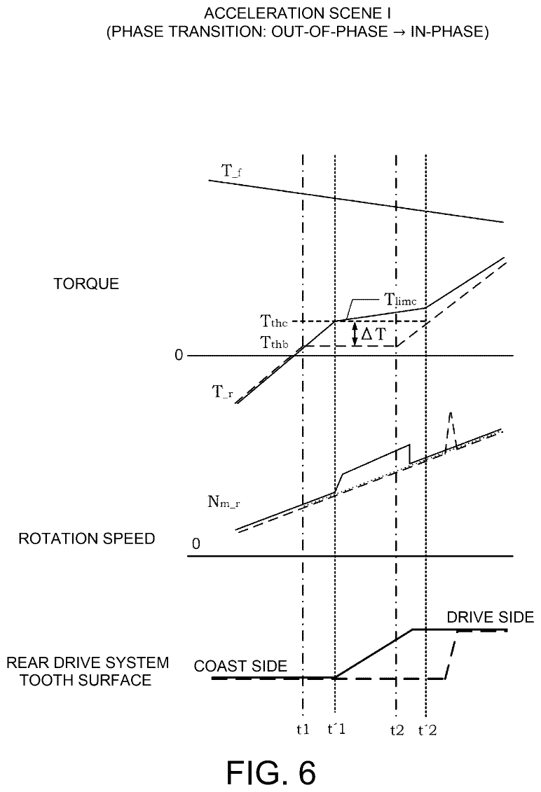

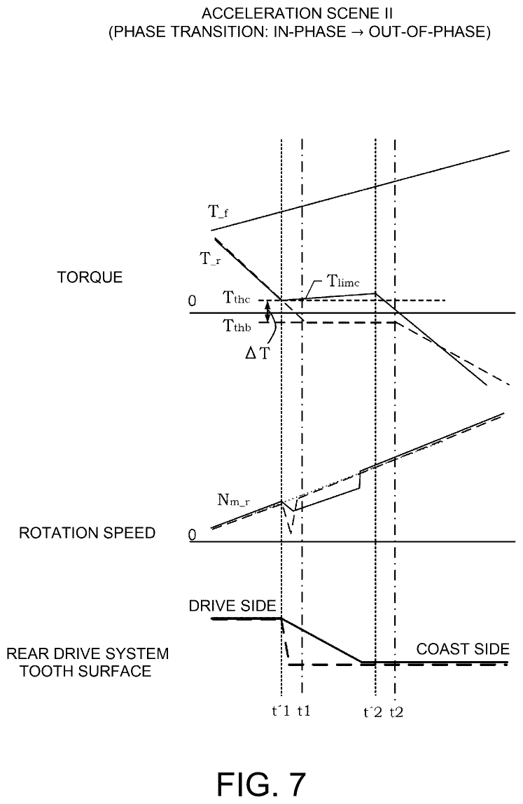

FIG. 6 is a timing chart showing a control result in a scene (hereinafter referred to as “acceleration scene I”) of phase transition from an out-of-phase (negative torque) to an in-phase (positive torque) during acceleration (acceleration a>0) of the vehicle 100. FIG. 7 is a timing chart showing a control result in a scene (hereinafter, referred to as “acceleration scene II”) of phase transition from the in-phase (positive torque) to the out-of-phase (negative torque) during acceleration of the vehicle 100.

Especially, in FIGS. 6 and 7, the control result by the backlash reducing control of the example is indicated by a solid line, and a control result by backlash reducing control of a comparative example is indicated by a broken line. Note that in the comparative example, it is assumed that the backlash reducing control is started at a timing (time t1) when the basic command rear motor torque T*_r reaches the basic control start torque Tthb regardless of the acceleration or deceleration state of the vehicle 100, and the rear motor torque T_r (final command rear motor torque T**_r) is maintained at the basic control start torque Tthb during the backlash reducing control.

In the backlash reducing control of the comparative example in the acceleration scene I shown in FIG. 6, the backlash reducing control is started when the rear motor torque T_r reaches the basic control start torque Tthb. During the backlash reducing control, the rear motor torque T_r is maintained at the basic control start torque Tthb. Therefore, the rear motor rotation speed Nm_r cannot pass the vehicle speed equivalent rotation speed (see the dotted line), and the backlash is not reduced during the backlash reducing control (time t1 to time t2). As a result, the backlash is rapidly reduced in a short time after the backlash reducing control is finished, and the backlash reducing shock becomes large.

On the other hand, in the backlash reducing control of the example, the backlash reducing control is started at a timing (time t′1) at which the rear motor torque T_r (basic command rear motor torque T*_r) reaches the correction control start torque Tthc greater than the basic control start torque Tthb, and during the backlash reducing control, the rear motor torque T_r is adjusted to the correction backlash reducing torque Tlimc greater than the basic control start torque Tthb. Therefore, during the backlash reducing control, the rear motor rotation speed Nm_r can be increased beyond the vehicle speed equivalent rotation speed to promote the backlash reducing. As a result, the backlash reducing time can be lengthened to reduce the shock during backlash reducing. Since a positive backlash reducing torque gradient A is set for the correction backlash reducing torque Tlimc, the rear motor torque T_r gradually increases during the backlash reducing control. Therefore, an effect of further increasing the rear motor rotation speed Nm_r can be obtained, and the backlash reducing effect can be further enhanced.

In the backlash reducing control of the comparative example in the acceleration scene II shown in FIG. 7, when the rear motor torque T_r reaches the basic control start torque Tthb (<0) after crossing the zero torque point, the backlash reducing control is started, and the rear motor torque T_r during the backlash reducing control is maintained at the negative basic control start torque Tthb. Therefore, the rear motor rotation speed Nm_r locally and sharply decreases during the backlash reducing control, and the backlash reducing shock increases.

In contrast, when the backlash reducing control of the present example is executed in the acceleration scene II, the backlash reducing control is started when the rear motor torque T_r reaches the correction control start torque Tthc (>0) before the zero torque point, and the rear motor torque T_r during the backlash reducing control is set to the positive correction backlash reducing torque Tlimc. Therefore, it is possible to prevent a local decrease in the rear motor rotation speed Nm_r during the backlash reducing control and reduce the backlash reducing shock. Also in the acceleration scene II, the rear motor torque T_r is adjusted to the correction backlash reducing torque Tlimc that gradually increases with a positive backlash reducing torque gradient A. Therefore, during the backlash reducing control, the increase in the rear motor rotation speed Nm_r can be further promoted, and the backlash reducing effect can be further enhanced.

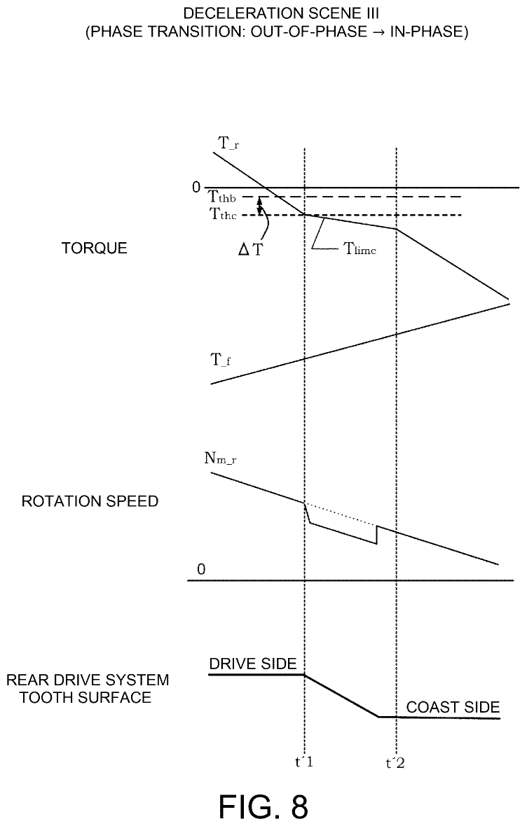

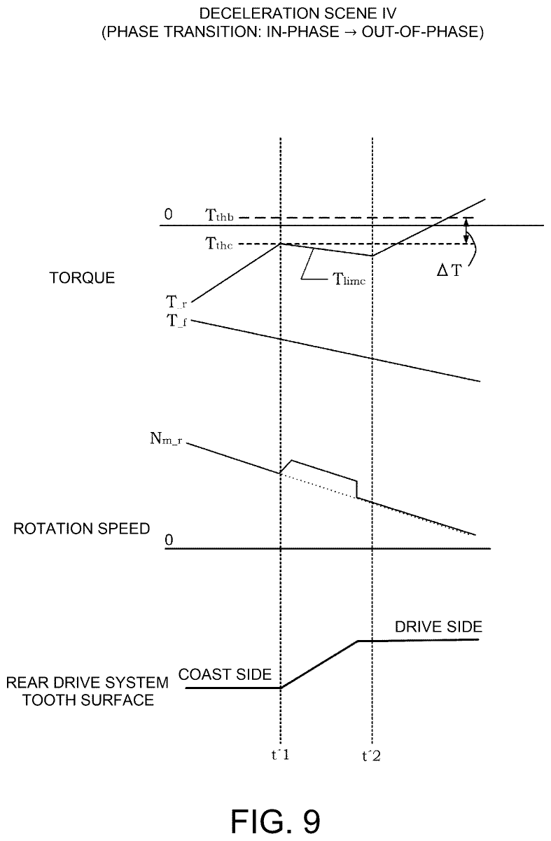

FIG. 8 is a timing chart showing a control result in a scene (hereinafter referred to as “deceleration scene III”) of phase transition from the out-of-phase (positive torque) to the in-phase (negative torque) during deceleration (acceleration a<0) of the vehicle 100. FIG. 9 is a timing chart showing a control result in a scene (hereinafter, referred to as “deceleration scene IV”) of phase transition from the in-phase (negative torque) to the out-of-phase (positive torque) during deceleration of the vehicle 100.

When the backlash reducing control of the example is executed in the deceleration scene III shown in FIG. 8, the backlash reducing control is started at a time t′1 at which the rear motor torque T_r (basic command rear motor torque T*_r) reaches the correction control start torque Tthc smaller than the basic control start torque Tthb. During the backlash reducing control, the rear motor torque T_r is adjusted to the correction backlash reducing torque Tlimc smaller than the basic control start torque Tthb. Therefore, the rear motor rotation speed Nm_r can be reduced below the vehicle speed equivalent rotation speed to promote the backlash reducing. As a result, the backlash reducing time can be lengthened to reduce the shock during backlash reducing. Since a negative backlash reducing torque gradient A is set for the correction backlash reducing torque Tlimc, the rear motor torque T_r gradually decreases during the backlash reducing control. Therefore, an effect of further decreasing the rear motor rotation speed Nm_r can be obtained, and the backlash reducing effect can be further enhanced.

When the backlash reducing control of the example is executed in the deceleration scene IV shown in FIG. 9, the backlash reducing control is started when the rear motor torque T_r reaches the correction control start torque Tthc (<0) before the zero torque point, and the rear motor torque T_r during the backlash reducing control is set to the negative correction backlash reducing torque Tlimc. Therefore, it is possible to prevent a local increase in the rear motor rotation speed Nm_r during the backlash reducing control and reduce the backlash reducing shock. Also in the deceleration scene IV, the rear motor torque T_r is adjusted to the correction backlash reducing torque Tlimc that gradually decreases with a negative backlash reducing torque gradient A. Therefore, during the backlash reducing control, the decrease in the rear motor rotation speed Nm_r can be further promoted, and the backlash reducing effect can be further enhanced.

Hereinafter, a configuration of the above-described present embodiment and functions and effects thereof will be collectively described.

In the present embodiment, there is provided a drive force control method for controlling, in the vehicle 100 including the drive devices (motors 10f and 10r) that are capable of driving independently in a front-rear direction, the torque distribution ratio κ between the motors 10f and 10r to cover an in-phase range in which signs of the motors 10f and 10r are the same, and an out-of-phase range in which the signs are different from each other.

In this drive force control method, the backlash reducing control is executed for limiting the magnitude (|T_r|) of the output torque (rear motor torque T_r) of the drive device (rear motor 10r) whose sign is inverted during phase transition to the magnitude (|T*_r|) of the basic command torque (basic command rear motor torque T*_r) determined according to the torque distribution ratio κ. Then, when the basic command torque (basic command rear motor torque T*_r) reaches the predetermined control start torque Tth, the backlash reducing control is started, and during acceleration and/or deceleration of the vehicle 100, the control start torque Tth is set to the correction control start torque Tthc different from the basic control start torque Tthb used during constant speed traveling.

Accordingly, in the scene in which the phase transition occurs during acceleration or deceleration of the vehicle 100, the backlash reducing torque Tlim of the drive device (the rear motor 10r in the present embodiment) whose sign of the torque is inverted can be appropriately adjusted, and the backlash reducing shock can be reduced.

In the present embodiment, during acceleration of the vehicle 100, the correction control start torque Tthc is set to a value greater than the basic control start torque Tthb (see FIGS. 6 and 7). On the other hand, during deceleration of the vehicle 100, the correction control start torque Tthc is set to a value smaller than the basic control start torque Tthb (see FIGS. 8 and 9).

Accordingly, during acceleration in which the rear motor rotation speed Nmr increases, the backlash reducing control is started at the correction control start torque Tthc greater than the basic control start torque Tthb. Therefore, it is possible to increase the rear motor torque Tr during the backlash reducing control as compared with the case of the constant speed traveling, and to promote an increase in the rear motor rotation speed Nmr. Therefore, it is possible to prevent the deviation of the rear motor rotation speed Nmr from the vehicle speed equivalent rotation speed during the backlash reducing control, and to enhance the backlash reducing effect. On the other hand, during deceleration in which the rear motor rotation speed Nmr decreases, the backlash reducing control is started at the correction control start torque Tthc smaller than the basic control start torque Tthb. Therefore, it is possible to reduce the rear motor torque Tr during the backlash reducing control as compared with the case of the constant speed traveling, and promote the reduction of the rear motor rotation speed Nmr. Therefore, it is possible to prevent the deviation of the rear motor rotation speed Nmr from the vehicle speed equivalent rotation speed during the backlash reducing control, and to enhance the backlash reducing effect.

Especially, the correction control start torque Tthc is determined according to the magnitude of the vehicle speed V of the vehicle 100.

Accordingly, the rear motor torque Tr during the backlash reducing control can be determined more appropriately in consideration of a friction that increases or decreases according to a gear acceleration inertia and the vehicle speed V.

Further, in the backlash reducing control, the rear motor torque Tr is increased or decreased in accordance with the increase or decrease direction of the vehicle speed V of the vehicle 100 with the correction control start torque Tthc as a base point.

Accordingly, during the backlash reducing control, the rear motor rotation speed Nmr can be increased or decreased so as to more quickly eliminate the separation from the vehicle speed equivalent rotation speed.

More specifically, in the backlash reducing control, during acceleration of the vehicle 100, the rear motor torque T_r is gradually increased over time with the correction control start torque Tthc as a base point (see FIGS. 6 and 7). On the other hand, during deceleration of the vehicle 100, the rear motor torque T_r is gradually reduced over time with the correction control start torque Tthc as a base point (see FIGS. 8 and 9).

As a result, during acceleration, the rear motor torque T_r gradually increases with the correction control start torque Tthc as a base point, so that it is possible to promote the increase of the rear motor rotation speed Nmr and to quickly approach the vehicle speed equivalent rotation speed. On the other hand, during deceleration, the rear motor torque T_r gradually decreases with the correction control start torque Tthc as a base point, so that it is possible to promote the decrease of the rear motor rotation speed Nmr and to quickly approach the vehicle speed equivalent rotation speed. As a result, the deviation of the rear motor rotation speed Nmr from the vehicle speed equivalent rotation speed can be eliminated more quickly, and the effect of reducing the backlash reducing shock can be further enhanced.

Further, in the backlash reducing control of the present embodiment, the increase or decrease amount (backlash reducing torque gradient A) of the rear motor torque T_r with the correction control start torque Tthc as a base point is adjusted according to the magnitude of the acceleration or deceleration (that is, the acceleration a) of the vehicle 100.

In consideration of the acceleration degree or the deceleration degree of the vehicle 100, the command value of the rear motor torque T_r during the backlash reducing control (that is, the correction backlash reducing torque Tlimc) can be determined more appropriately from the viewpoint of eliminating the deviation between the rear motor rotation speed Nmr and the vehicle speed equivalent rotation speed.

In the present embodiment, the controller 50 that functions as a drive force control device for executing the drive force control method is provided.

Especially, the controller 50 includes the backlash reducing control unit 60 that executes the backlash reducing control for limiting the magnitude (|T_r|) of the output torque (rear motor torque T_r) of the drive device (rear motor 10r) whose sign is inverted during phase transition to the magnitude (|T*_r|) of the basic command torque (basic command rear motor torque T*_r) determined according to the torque distribution ratio κ. Then, when the basic command torque (basic command rear motor torque T*_r) reaches the predetermined control start torque Tth, the backlash reducing control unit 60 starts the backlash reducing control, and during acceleration and/or deceleration of the vehicle 100, sets the control start torque Tth to the correction control start torque Tthc different from the basic control start torque Tthb used during constant speed traveling.

Although the embodiment of the present invention has been described above, the above embodiment merely exemplifies some of application examples of the present invention and does not intend to limit the technical scope of the present invention to the specific configurations of the above embodiment.

For example, the specific calculation logic for determining the correction control start torque Tthc or the correction backlash reducing torque Tlimc described in the above embodiment is not limited to the mode in the above embodiment, and various modifications can be made within the scope of the gist of the present invention, and in the above embodiment, an example has been described in which the torque distribution ratio κ that is a premise when executing the backlash reducing control is a value determined based on the pitch reduction control. However, as the control for determining the prerequisite torque distribution ratio κ, any control (for example, slip control when traveling on a special road surface or the like) that can determine the torque distribution ratio κ covering the in-phase range and the out-of-phase range can be applied in addition to the pitch reduction control.

1. A drive force control method for controlling a torque distribution ratio between drive devices provided in a vehicle that are capable of driving independently in a front-rear direction, to cover an in-phase range in which signs of output torques of the drive devices are equal, and an out-of-phase range in which the signs are different from each other, the method comprising:
executing backlash reducing control of limiting a magnitude of the output torque of one of the drive devices whose sign is inverted during phase transition to a magnitude of a basic command torque determined according to the torque distribution ratio, wherein
the backlash reducing control is started when the basic command torque reaches a predetermined control start torque, and
during acceleration and/or deceleration of the vehicle, the control start torque is set to a correction control start torque different from a basic control start torque used during constant speed traveling.

2. The drive force control method according to claim 1, wherein
the correction control start torque is set to a value greater than the basic control start torque during acceleration of the vehicle, and
the correction control start torque is set to a value smaller than the basic control start torque during deceleration of the vehicle.

3. The drive force control method according to claim 1, wherein the correction control start torque is determined according to a magnitude of a vehicle speed of the vehicle.

4. The drive force control method according to claim 1, wherein, in the backlash reducing control, the output torque is increased or decreased according to an increase or decrease direction of a vehicle speed of the vehicle with the correction control start torque as a base point.

5. The drive force control method according to claim 4, wherein, in the backlash reducing control,
the output torque is gradually increased over time with the correction control start torque as a base point during acceleration of the vehicle, and
the output torque is gradually decreased over time with the correction control start torque as a base point during deceleration of the vehicle.

6. The drive force control method according to claim 4, wherein, in the backlash reducing control, an increase or decrease amount of the output torque with the correction control start torque as a base point is adjusted according to a magnitude of an acceleration or a deceleration of the vehicle.

7. A drive force control device that determines a torque distribution ratio between drive devices provided in a vehicle that are capable of driving independently in a front-rear direction, to cover an in-phase range in which signs of output torques of the drive devices are equal, and an out-of-phase range in which the signs are different from each other, the drive force control device comprising:
a control unit configured to execute backlash reducing control of limiting a magnitude of the output torque of one of the drive devices whose sign is inverted during phase transition to a magnitude of a basic command torque determined according to the torque distribution ratio, wherein the control unit is configured toto:
start the backlash reducing control when the basic command torque reaches a predetermined control start torque; and
set, during acceleration and/or deceleration of the vehicle, the control start torque to a correction control start torque different from a basic control start torque used during constant speed traveling.
